(19) United States
(12) Patent Application Publication
(10) Pub. No.: US 2019/0317879 A1
(43) Pub. Date: Oct. 17, 2019

(54) DEEP LEARNING FOR SOFTWARE DEFECT IDENTIFICATION

(71) Applicant: William Carson MCCORMICK, Ottawa (CA)

(72) Inventor: William Carson MCCORMICK, Ottawa (CA)

(73) Assignee: Huawei Technologies Co., Ltd., Shenzhen (CN)

(21) Appl. No.: 15/953,650

(22) Filed: Apr. 16, 2018

(51) Int. Cl. G06F 11/36; G06F 8/75; G06K 9/62; G06N 3/04

(52) U.S. Cl. CPC G06F 11/3608; G06F 8/75; G06F 11/3664; G06K 9/6256; G06N 3/0454; G06K 9/6232

(57) ABSTRACT

A neural network for identifying defects in source code of computer software. The neural network comprises: at least one convolutional layer configured to generate a one or more feature abstractions associated with an input segment associated with the source code; at least one recurrent layer configured to identify within the one or more feature abstractions a pattern indicative of a defect in the source code; and at least one mapping layer configured to generate a mapping between the identified pattern and a location of the indicated defect in the source code.

### FIELD OF THE INVENTION

The present invention pertains to the field of software defect identification, and in particular to deep learning for software defect identification.

### BACKGROUND

Various techniques are known in the art for analysing computer software for defects. For example, static code analysis techniques may be used to analyse the source code of a software program to detect either or both of syntax and logic errors. This can be done without actually executing the software. In addition, techniques such as execution logging can be used to track the evolving state of a set of program variables during execution of the software, to detect unexpected operations.

Both of these techniques suffer limitations in that they depend on predefined rule sets to detect errors. These rules are typically defined by a human operator, and are often based on patterns that would be recognizable and easily checkable. Accordingly, they tend to be very effective at detecting commonly occurring defects (such as uninitialized pointers), for which robust rules have been developed. However, they tend to be far less effective at detecting rarely occurring and/or complex defects that occur during run-time (such as stack overflow).

This background information is provided to reveal information believed by the applicant to be of possible relevance to the present invention. No admission is necessarily intended, nor should be construed, that any of the preceding information constitutes prior art against the present invention.

### SUMMARY

An object of embodiments of the present invention is to provide software defect identification that overcome at least some of the limitations of the prior art.

Accordingly, an aspect of the present invention provides a neural network for identifying defects in source code of computer software. The neural network comprises: at least one convolutional layer configured to generate a one or more feature abstractions associated with an input segment associated with the source code; at least one recurrent layer configured to identify within the one or more feature abstractions a pattern indicative of a defect in the source code; and at least one mapping layer configured to generate a mapping between the identified pattern and a location of the indicated defect in the source code.

### BRIEF DESCRIPTION OF THE FIGURES

Further features and advantages of the present invention will become apparent from the following detailed description, taken in combination with the appended drawings, in which:

FIGS. 1A and 1B illustrate elements of respective neural network architectures known in the art;

FIG. 2 is a flow diagram illustrating an example process for compiling a source code to an executable file;

FIG. 3 is a flow diagram illustrating an example process in accordance with representative embodiments of the present invention;

FIG. 4 illustrates a representative method of formatting parse trees to produce an input array that can be supplied to a neural network in the example process of FIG. 3;

FIG. 5 is a block diagram illustrating an example neural network usable in the process of FIG. 3; and

FIG. 6 illustrates a process for training the neural network in accordance with representative embodiments of the present invention.

It will be noted that throughout the appended drawings, like features are identified by like reference numerals.

### DETAILED DESCRIPTION

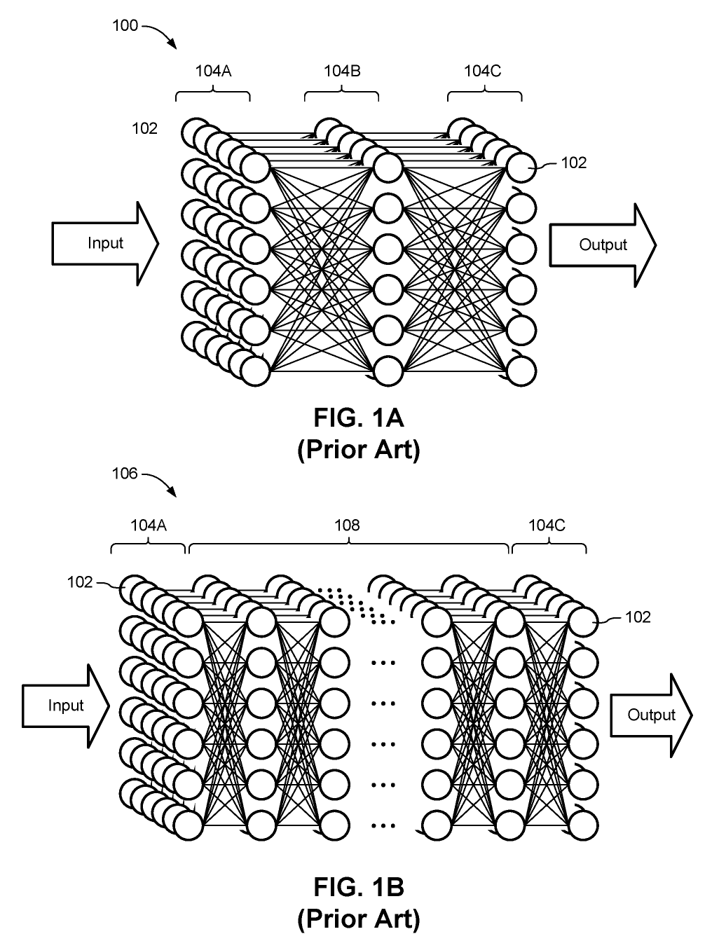

FIG. 1A illustrates elements of a simple neural network 100. As may be seen in FIG. 1A, the neural network 100 comprises a plurality of nodes 102 arranged in a set of three layers 104A-C. A first layer 104A is configured to receive and process input data, and passes the resulting processed signals to the middle layer 104B. The middle layer 104B of the neural network 100 receives and processes signals from the input layer 104A, and passes the resulting processed signals to the third layer 104C. The third layer 104C is configured to receive and process signals from the middle layer 104B to generate output data. In some references, the first layer 104A may be referred to as an input layer, while the third layer 104C may be referred to as an output layer. In a fully connected neural network, each node 102 within a given layer is connected to all of the nodes in the successive layer. Thus, for example, each node 102 of the input layer 104A is connected to every node 102 of the middle layer 104B, and each node of the middle layer 104B is connected to every node 102 of the output layer 104C.

Typically, each node implements a transfer function which maps input signals received through each of its input ports to output signals that are transmitted through each of its output ports. The transfer function applies weights to each of the input values received at a given node, and then combines them (typically through a set of operations such as addition, subtraction, division or multiplication) to create an output value. The output value is then transmitted on each of the output ports. The weighting factors applied to the inputs (along with the particular transfer function itself) control the propagation of signals through the neural network 100 between the input layer 104A and the output layer 104C. In some embodiments, the process of “training” the neural network (or unsupervised learning) typically comprises adjusting the weighting factors so that a predetermined input data set will produce a desired output data set.

FIG. 1B illustrates elements of a so-called “deep” neural network 106. Deep neural network 106 is similar to the simple neural network 100 of FIG. 1A, in that they both include an input layer 104 and an output layer 104C. However, the neural network 106 comprises a plurality of middle layers 108. In some embodiments, there may be in excess of 20 middle layers. These middle layers may comprise any combination of fully interconnected layers (e.g. every node of one layer is connected to all of the nodes of a next layer) and partially interconnected layers (e.g. a node of one layer is connected to a subset of the nodes of a next layer). Different nodes in each layer may implement different transfer functions, and in the case of partially interconnected layers, may have different connectivity that other nodes in the network.

As in the simple neural network 100 of FIG. 1A, each node of the neural network 106 implements a transfer function which maps input signals received through each of its input ports to output signals that are transmitted through each of its output ports. By increasing the number of layers, of a variety of different behaviors can be trained. These behaviors can be defined by the connectivity between nodes and the transfer function applied at each node. Such neural networks have been widely used for pattern recognition, such as for recognizing features (such as faces) in photographs and videos. The ability for a neural network to perform such a recognition is typically a result of setting the transfer functions of each node through a training process in which a set of known inputs are provided and transfer functions are adjusted to obtain the output desired.

The present invention provides methods and systems that exploit the pattern-recognition capability of neural networks to identify defects in computer software.

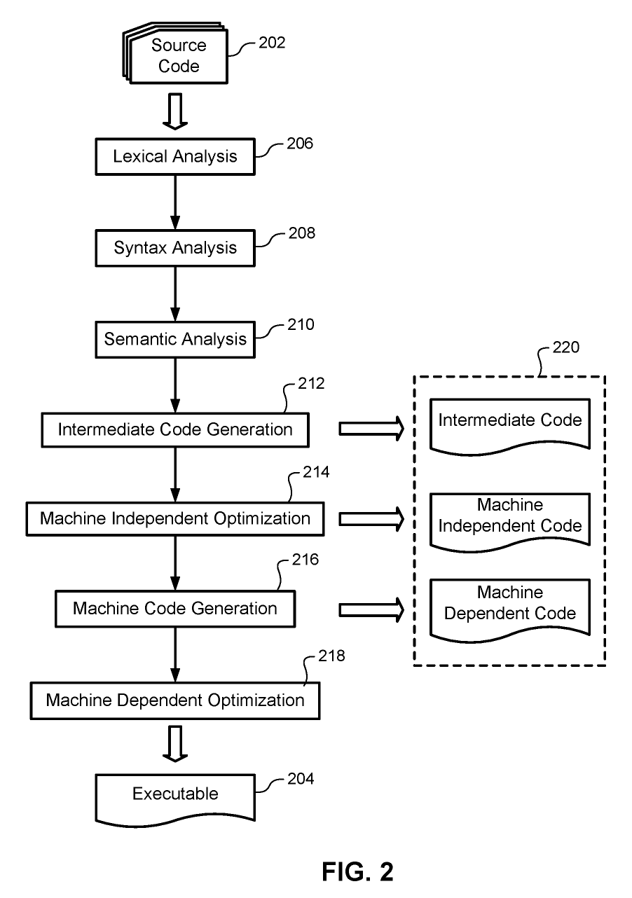

FIG. 2 is a flow-chart illustrating representative processing stages that are implemented by a compiler. As may be seen in FIG. 2, the compiler receives and processes source code 202 to produce an executable code 204 that is optimized for execution on a processor. The initial processing stages may include: a Lexical Analysis 206 which converts each line of the source code 202 into tokens by removing spaces and comments; a Syntax Analysis 208 or parser which derives a parse tree of each token, and compares each parse tree to production rules to detect syntax errors; and a Semantic Analysis 210 which uses context and type information from the source code 202 to determine what the types of various values are, how those types interact in expressions, and whether those interactions are semantically reasonable. Each of the Lexical Analysis 206, Syntax Analysis 208, and Semantic Analysis 210 can detect errors within the source code. Typically, if the source code 202 can pass through these initial processing stages without errors, then the source code 202 can be successfully compiled to executable code 204. However, there may still be logic errors in the source and executable code that are not detected during semantic checks but may produce unpredictable and typically undesirable effects.

Typically, a parse tree is implemented as string of the form: Symbol1:=Operation(Symbol2,Symbol3), where “Operation” is a functional operation of a particular computing language, Symbol2 and Symbol3 are values upon which “Operation” acts, and Symbol1 is a value that receives the result of “Operation” acting on Symbol2 and Symbol3. It will be appreciated that either one or both of Symbol2 and Symbol3 may themselves be values that receive the results of other operations.

Following completions of the Semantic Analysis 210, a multi-pass process is typically implemented to convert the parse trees into the Executable code 204. In the example of FIG. 2, the multi-pass process is implemented four stages (or passes), comprising: Intermediate Code Generation 212; Machine Independent Optimization 214; Machine Code Generation 216; and Machine Dependent optimization 218.

Intermediate Code Generation 212 normally involves replacing the parse trees with corresponding machine Opcodes that can be executed on a processor. In many cases this process may be implemented as a simple replacement operation, as parse tree string is replaced by its Opcode equivalent.

Machine Independent Optimization 214 typically involves selecting an order of operation of the Opcodes selected by the Intermediate Code Generation 212, for example to maximize a speed of execution of the executable code 204.

Machine code generation 216 normally involves replacing the machine Opcodes with corresponding Machine Code that can be executed on a specific processor.

Machine Dependent Optimization 218 typically involves selecting an order of operation of the Machine Code generated by the Machine code generation 216 stage, for example to exploit pipelining to maximize performance of the executable code 204.

As illustrated in FIG. 2, each of the code generation and optimization processes 212-218 produce intermediate representations 220 of the that source code 202, that contain the complete logical structure of the source code 202 in a form that can be more readily interpreted and processed by a machine.

Embodiments of the present invention provides methods and systems for detecting defects in the source code 202 associated with the logic of the source code, or associated with errors that would not otherwise be detectable through the conventional Lexical, Syntactic, or Semantic analysis. Example defects of the type that can be detected using methods in accordance with the present invention include logic errors, stack overflow errors, improperly terminated loops etc. In some embodiments, parse trees output from the semantic analysis process 210 of a compiler may be analysed to detect defects. In other embodiments, one or more intermediate representations 220 may be analysed to detect defects.

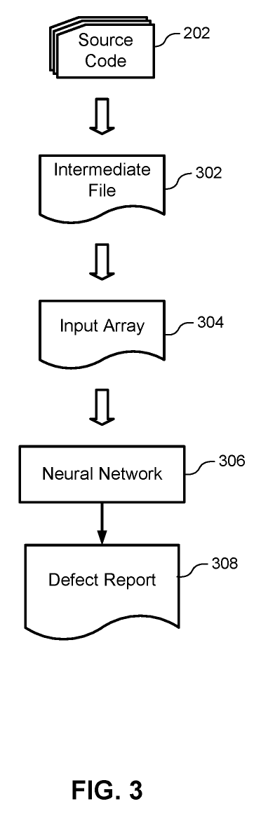

FIG. 3 illustrates a representative process in accordance with an embodiment of the present invention. As may be seen in FIG. 3, source code 202 is processed, as described above with reference to FIG. 2 to produce an input file 304 comprising parse trees (that are free of lexical, syntactic, or semantic errors) and/or intermediate representations 220. The input file 304 can then be reformatted to generate an input array that is presented to a neural network 306 configured to detect defects in the intermediate file 302 (and thus the source code 202), and generate a defect report 308 identifying any detected defects.

In some embodiments, the input array may include information that can be used to identify a location at which a defect is detected. For example, each parse tree may include a respective identifier. Similarly, each intermediate representation 220 may include line numbers or other identifiers. When a logic defect is detected by the neural network 306, a description of the defect can be inserted into the defect report 308 along with an identifier indicating the location (e.g. the parse tree, or intermediate representation line) at which the defect was detected. In some embodiments, the identifier included in the defect report may be mapped to a corresponding location in the source code 202, for example during a post-processing step (not shown).

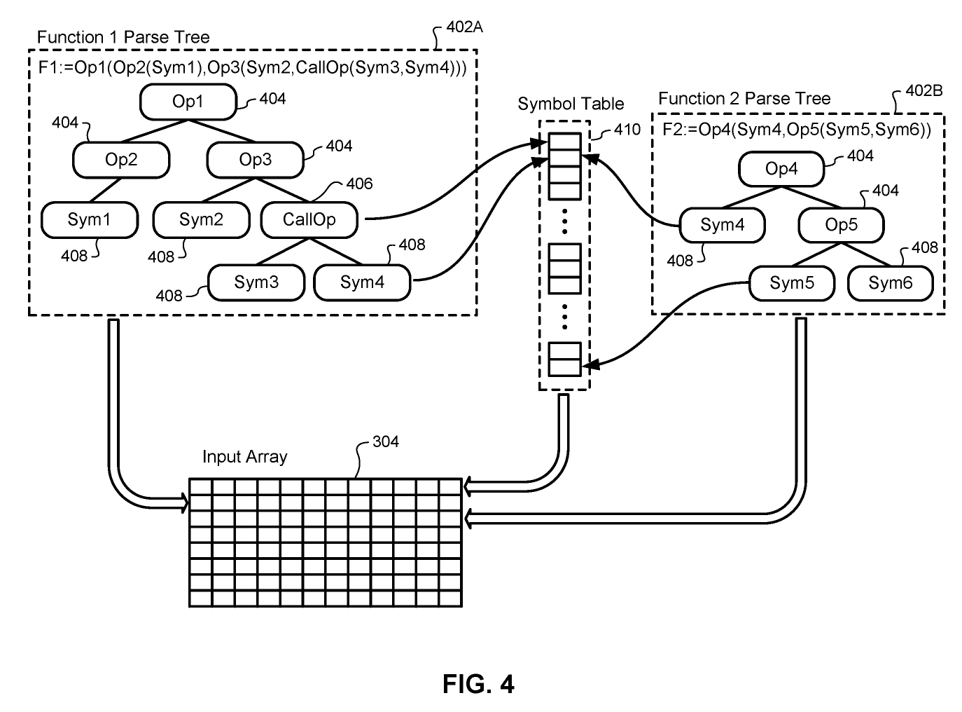

FIG. 4 schematically illustrates a representative method of formatting parse trees to produce an input array 304 that can be supplied to the neural network 306. It will be appreciated that directly analogous methods may be used to format an intermediate representation 202 into an input array 304. In the example of FIG. 4, a pair of parse trees 402A and 402B are shown in both a string and a graphical representation. For example, Function 1 402A comprises three operations 404 (Op1 . . . Op3), a Call Operation 406 (such as an object call, for example) and four symbols 408 (Sym1 . . . Sym4). Similarly, Function 2 402B comprises two operations 404 (Op4 and Op5), and three symbols 408 (Sym4 Sym6). In the illustrated embodiment, each symbol 408 can be inserted into a respective location in a symbol table 410, which may be loaded into a first row of the input array 304. Each function parse tree may then be used to populate successive rows of the input array 304, as shown in FIG. 4.

In an alternative embodiment, the symbol table 410 may be loaded into a first column of the input array 304, rather than the first row. In still other embodiments, the symbol table 410 may be loaded into both the first row and the first column of the input array 304. In this latter embodiment, each operation 404 can be loaded into the input array, for example at the cell in the row and column corresponding to the symbols 408 associated with that operation.

In very general terms, the input array 304 (as an intermediate representation of the source code) may be supplied to the input layer of the neural network 306. However, it may be appreciated that in many cases the size of the input array 304 may not match the input vector length of the neural network 306, which will normally have a predetermined upper bound. Accordingly, the input array 304 may be processed (for example using methods known in the art) to generate a plurality of input segments that match the input vector length of the neural network 306. In some embodiments, processing the input array 304 to generate the input segments may comprise allocating predetermined portions (such as a set of one or more rows or columns) of the input array 304 to each input segment. The size of each input segments may be set by the system, or it may be be based on elements (such as recognized comments and flags, for example) in the source code.

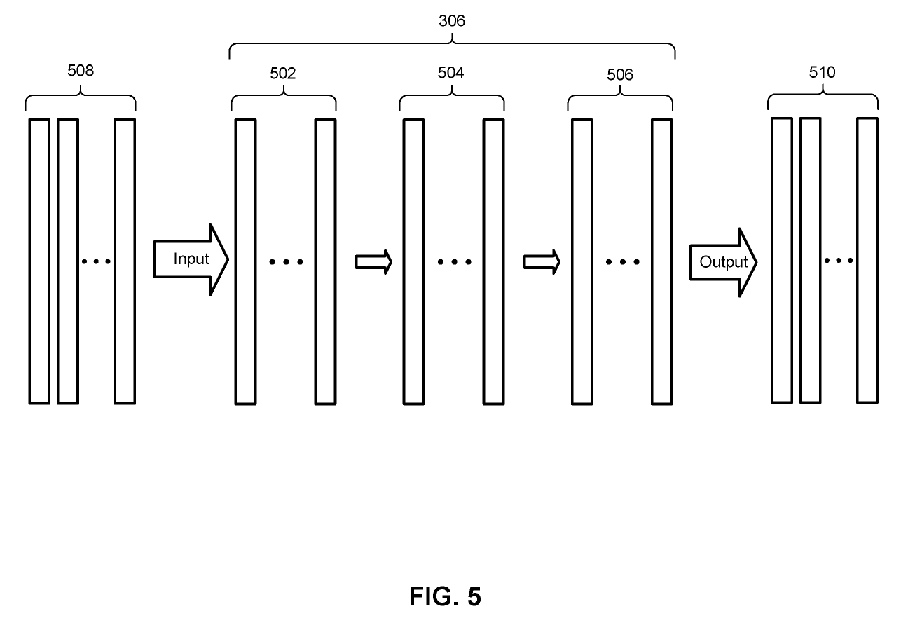

FIG. 5 is a block diagram illustrating an example architecture of the neural network 306. In the example of FIG. 5 the neural network 306 comprises one or more convolutional layers 502; one or more recurrent layers 504; and one or more functionally fully connected layers 506.

The convolutional layers 502 are configured to receive and process input segments 508 to perform feature detection and reduce the complexity of the input data. In some embodiments, the convolutional layers 502 may generate one or more feature abstractions associated with each input segment 508. Each feature abstraction may correspond with a programming feature of the source code, which may include any one or more of: selections (such as if/then/else, switch); repetitions (such as for, while, do while); flow controls (such as break, continue, goto, call, return, exception handling); expressions (such as assignment, evaluation; compound statements (such as atomic/synchronized blocks); and events or event triggers.

In some embodiments, each convolutional layer may include a convolutional sublayer and a pooling sublayer. The convolutional sublayer may be configured to recognize features (such as loops, function calls, object references; and events or event triggers) in the source code. The pooling sublayer may be configured to sub-sample the output of the convolution (using either average or maximum pooling, for example) to improve resolution.

The recurrent layers 504 are configured to receive and process feature abstractions generated by the convolutional layers 502, to identify patterns which span multiple input segments. For example, the pattern associated with an individual feature (or feature abstraction) may indicate the presence of a defect in the source code based on how the pattern appears, or based on how features are identified with respect to each other.

Recurrent layers 504 may have a shared memory (not shown), so that patterns can be detected across input segments.

Specific types of recurrent layers 504 include: long short term memory (LSTM); and Gated recurrent units.

The functionally fully connected layers 506 are configured to generate a mapping between the identified pattern and a location of the indicated defect in the source code. For example, when the pattern of a defect in the source code is identified by the recurrent layers 504, there is a likelihood of a problem in a particular feature of the source code. The functionally fully connected layers 506 operate to map this (potentially defective) feature to a location in the source code. This location might be as fine as a range of lines within the source code that has a defect (e.g. there is a variable used in a small range that will generate an overflow error), or it might be something that identifies a relatively broad section of the source code and indicates that there is a likely problem with a given type of structure (e.g. in a large block of code, there may be a loop that will not properly terminate, or there may be a variable that will be assigned a value during a loop that will result in an overflow error).

Effectively, the purpose of this layer is to pull the recognized errors back together with the source code, in order to facilitate correction of the defect.

As may be appreciated, a fully connected layer is one where each output of a one layer is connected to an input of the next layer. In some embodiments, the functionally fully connected layers 506 are configured as fully interconnected layers. In other embodiments, two or more layers of the functionally fully connected layers 506 are not, in fact, fully interconnected, but are nevertheless configured to yield the same results as a fully connected layer. In such embodiments, such layers trade off the breadth of the connections between layers (which results in each layer having to move a large amount of data at once) for a less broad set of connections between layers, but with an increase in the depth of the number of layers. The term “functionally” fully interconnected layers is used herein to refer to both layers that are in fact fully interconnected, and layers that are not fully interconnected but are configured to yield the same results as fully interconnected layers.

In the embodiment of FIG. 5, the output of the functionally fully connected layers 506 is the defect report 308, which in this example takes the form of a set of one or more output segments 510.

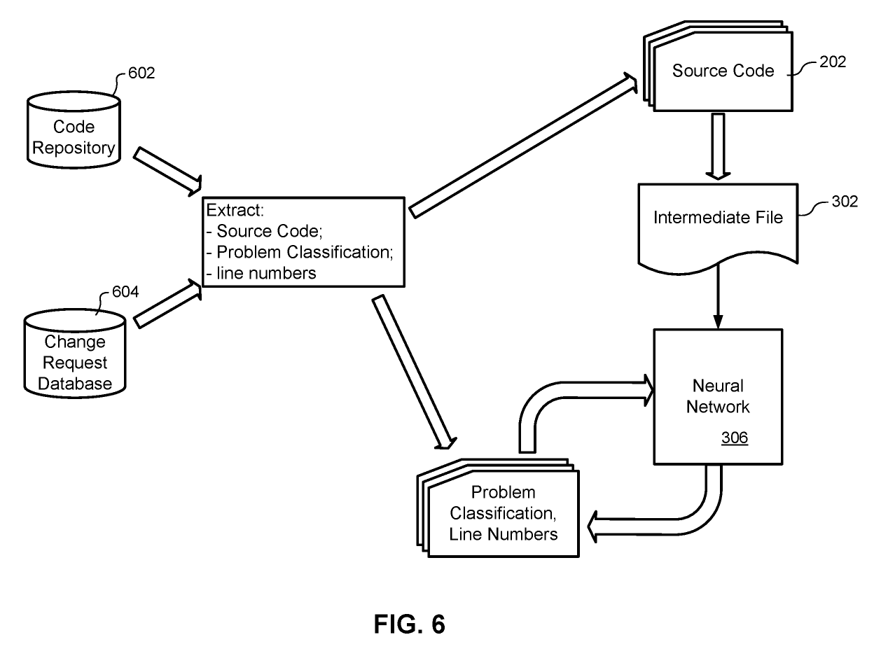

FIG. 6 schematically illustrates a process for training the neural network 306 to identify defects. In the example of FIG. 6, a code repository 602 stores a respective version history of one or more software applications, and a Change Request Database 604 stores a corresponding history of changes made to each version of the application. For example, during the development of a software application, it is common for numerous versions of the application to be developed and tested to identify and correct defects. As each new version is tested, the defects detected in that version, and the changes made to correct those defects, are recorded. The multiple versions of the application may be stored, in order of the sequence in which the versions were created, in the Code repository 602, while the defects detected in each version and the steps taken to correct those defects are recorded in the Change Request Database 604.

In embodiments of the present invention, the version history stored in the Code Repository 602, and the corresponding history of defects detected in and changes made to each version of the application stored in the Change Request Database 604 are processed to extract blocks of source code that contain defects, and information describing those defects. In the illustrated example, the defect description information includes a problem classification that describes the defect, and a line number that identifies a location in the source code block at which the defect is located. The extracted software blocks, and the corresponding defect description information are used to define a training set for the neural network 306. For example, a selected block of source code may be processed as described above with reference to FIGS. 3 and 4 to generate an intermediate file 302 and present an input array 304 to the neural network 306. At the same time, the corresponding defect description information (e.g. problem classification and line number) may be presented to the neural network 306. By this means, the neural network 306 can be trained to detect software defects, and generate appropriate defect description information, which can be recorded in a defect report.

Although the present invention has been described with reference to specific features and embodiments thereof, it is evident that various modifications and combinations can be made thereto without departing from the invention. The specification and drawings are, accordingly, to be regarded simply as an illustration of the invention as defined by the appended claims, and are contemplated to cover any and all modifications, variations, combinations or equivalents that fall within the scope of the present invention.

1. A deep learning neural network for identifying defects in source code of computer software, the neural network comprising:
a convolutional layer configured to receive an input segment associated with the source code and to generate a set of one or more feature abstractions associated with the input segment;
a recurrent layer configured to identify within the one or more feature abstractions a pattern indicative of a defect in the source code; and
a mapping layer configured to generate a mapping between the identified pattern and a location in the source code associated with the indicated defect.

2. The deep learning neural network of claim 1 wherein the input segment comprises an intermediate representation of at least a portion of the source code.

3. The deep learning neural network of claim 2 wherein the input segment is received by the convolutional layer from a compiler associated with the neural network.

4. The deep learning neural network of claim 1 wherein at least one of the feature abstractions in the generated set corresponds with a programming feature of the source code selected from a list comprising
a selection;
a repetition;
a flow control;
an expression;
a compound statement; and
an event;

5. The deep learning neural network of claim 1 wherein the convolutional layer is further configured to create a pool of feature abstractions within the generated set of one or more feature abstractions, each feature abstraction within the pool of feature abstractions associated with a common input segment.

6. The deep learning neural network of claim 1 wherein the convolutional layer is a one of a plurality of convolutional layers in the neural network.

7. The deep learning neural network of claim 6 wherein each of the plurality of convolutional layers is connected to at least one other convolutional layer.

8. The deep learning neural network of claim 1 wherein the identifying of a pattern is performed in accordance with contents of a memory associated with the recurrent layer.

9. The deep learning neural network of claim 1 wherein the recurrent layer is a one of a plurality of recurrent layers in the neural network.

10. The deep learning neural network of claim 9 wherein each of the plurality of recurrent layers is connected to at least one other recurrent layer.

11. The deep learning neural network of claim 9 wherein the identifying of a pattern is performed in accordance with contents of a plurality of memories, each memory in the plurality of memories associated with at least one layer in the plurality of recurrent layers.

12. The deep learning neural network of claim 11 wherein at least one memory in the plurality of memories is a shared memory and is associated with more than one layer in the plurality of recurrent layers, the shared memory facilitating identification of errors across input segments.

13. The deep learning neural network of claim 1 the mapping layer is one of a plurality of mapping layers, and wherein each of the plurality of mapping layers is connected to at least one other mapping layer.

14. The deep learning neural network of claim 13 wherein the at least two of the plurality of mapping layers are functionally fully connected.

15. The deep learning neural network of claim 14 wherein the at least two functionally fully connected mapping layers are fully connected.

16. The deep learning neural network of claim 1 wherein the mapping layer is configured to generate the mapping in accordance with the identified patterns indicative of a defect identified by the recurrent layer and segment information received from the recurrent layer.
